(19) United States
(12) Patent Application Publication
(10) Pub. No.: US 2011/0159468 A1
(43) Pub. Date: Jun. 30, 2011

(54) Process And Apparatus For Anger And Behavior Management

(76) Inventor: Maria Krautner, Walnut Creek, CA (US)

(21) Appl. No.: 12/951,299

(22) Filed: Nov. 22, 2010

Related U.S. Application Data
(60) Provisional application No. 61/288,113, filed on Dec. 18, 2009.

(51) Int. Cl. G09B 19/00

(52) U.S. Cl. 434/236

(57) ABSTRACT

A method is performed to manage a secondary emotion such as anger, allowing the user to choose their behavior in response to the primary emotion thereby managing their behavior. The user turns on a figurine which plays back a message which invites the user to complete the process. The user names and records on a note the primary emotion being experienced. Then, the user claims this primary emotion as being responsible for the anger and records this on the note. Then, the user deposits this note into a figurine that disposes the note. This last step, by disposing the note, symbolically releases the anger, which helps the user manage anger and reminds the user of their power to choose their response to feelings of anger. The apparatus comprises a figurine containing, in one embodiment, a voice module to play back a message and a paper shredder to dispose the note.

### FIELD OF THE INVENTION

The disclosure herein relates generally to a process and apparatus for use in behavior management, particularly for use in anger management.

### BACKGROUND

Anger, and its related outcomes, has a number of costly societal con-sequences. In the US alone, about 3 million people are in prison, on parole, or on probation. Half of these people were involved in violent crimes. In such cases, anger was often a factor. Pharmaceutical therapies, counseling, and other modalities have been employed to address such behavioral issues.

An apparatus developed by Dara-Abrams (U.S. Pat. No. 4,900,256) helps children resolve emotional conflicts with an apparatus and method having programmed psychological exercises. The apparatus and method is used by selecting programmed psychological exercises by manipulating actuating devices in the apparatus, listening to programmed exercises, and carrying out specified activities in the manner directed by instructions and sound effects provided by the apparatus.

The personal therapeutic device and method (Kirschenbaum, Kramer and Smith; U.S. Pat. No. 5,217,379) takes a different tack. This device plays back to its user a recorded message having a semantic content relating to modifying certain behaviors of the user. The playback may occur at intervals random or regular, either in response to programming of the device, or to remote actuation by the user's therapist, counselor, or any other individual involved in the user's behavior modification process.

A device developed by Rose (U.S. Pat. No. 6,595,779) relates to behavior modification and the like in human subjects, and particularly, but not exclusively, to performance enhancement. The invention provides a device comprising control means operable, in use, to monitor a recorded message being played to a human subject, and actuator means operable to provide a perceptible stimulation to the human subject, the control means being further operable, at least selectively, to activate the actuator means at a predetermined point or points in the message. The invention seeks to provide apparatus which facilitates behavior modification.

Wilson (U.S. patent application Ser. No. 12/006,553) developed a self-implementable method for promoting a positive personal emotional condition in response to certain contra-stimuli. The methodology features promoting a positive personal emotional condition. In particular, it features such “promoting” activity employing the steps of: (a) choosing a readily repeatable, “normal-delivery-pace” message pattern, such as (1) a sound message pattern, (2) a visual message pattern, (3) a tactile message pattern, or (4) another suitable form of employable message pattern; (b) associating the chosen message pattern positively with an internalized practice of implementing the mentioned positive-emotional-condition promoting activity; (c) storing the chosen message pattern in at least one, selected, personally-proximate and suitable storage medium; and (d), on the occurrence of a defined contra-stimulus category, or the occurrences each of different, defined, contra-stimulus categories, deploying (for example, playing out, or otherwise presenting), from the selected storage medium, at least one personally engaging, “normal-delivery-pace” occurrence of the relevant stored message pattern so as to invoke the mentioned, associated, internalized, positive-emotional-condition promoting-activity practice.

### SUMMARY

Disclosed herein is a method and apparatus for anger and behavior management. A note provides for areas for naming a primary emotion, for claiming a behavior and, optionally, for instructions. A figurine having an interface which includes a switch knob, a receptacle and a lid. Associated with the figurine is a power supply, switch, controller, receptacle sensor, disposer and announcement module.

According to one aspect of the invention, there is provided a method in which the user starts the figurine to play back an announcement, names the primary emotion on the note, claims the secondary emotion on the note and disposes the note in the figurine thereby symbolically releasing the secondary emotion such as anger and reminding the user of their power to choose their behavior thereby manage both their secondary emotion and behavior. According to another aspect of the invention, there is provided a method in which the user names the primary emotion on the note, claims the secondary emotion on the note, starts the figurine to play back an announcement and disposes the note in the figurine thereby symbolically releasing the secondary emotion such as anger and reminding the user of their power to choose their behavior thereby manage both their secondary emotion and behavior. The figurine and its components maybe icons and processes that are controlled by a process on a memory device.

The construction and method of operation of the invention, however, together with additional objectives and advantages thereof will be best understood from the following description of specific embodiments when read in connection with the accompanying drawings.

### BRIEF DESCRIPTION OF DRAWINGS

### Figures

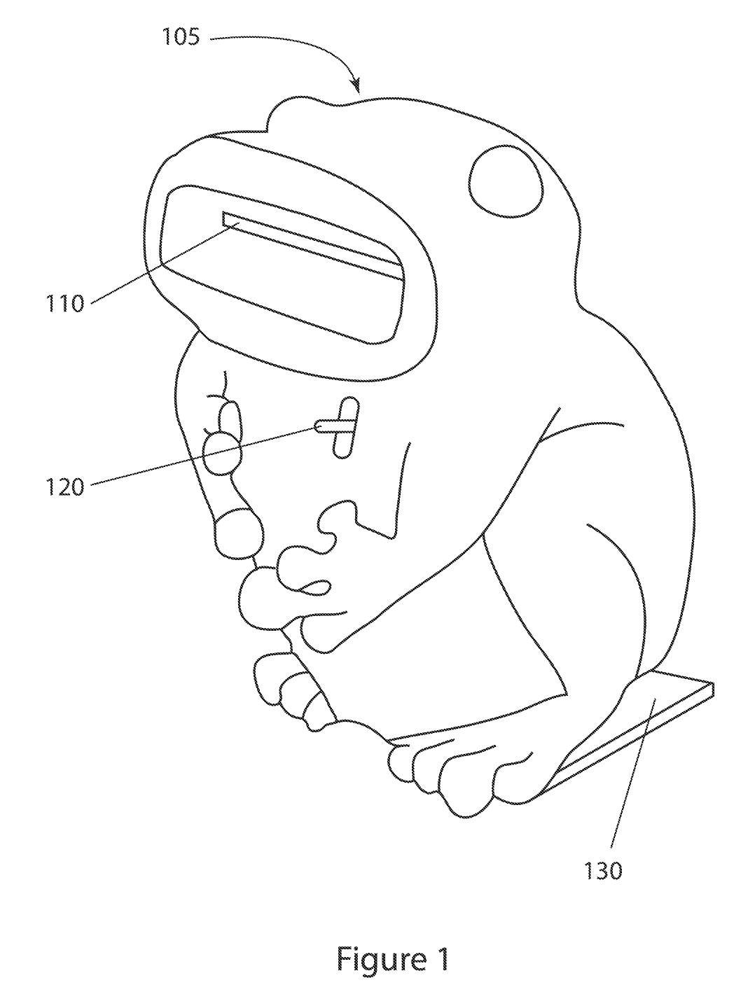

FIG. 1. Illustrates the perspective view of one embodiment of the figurine.

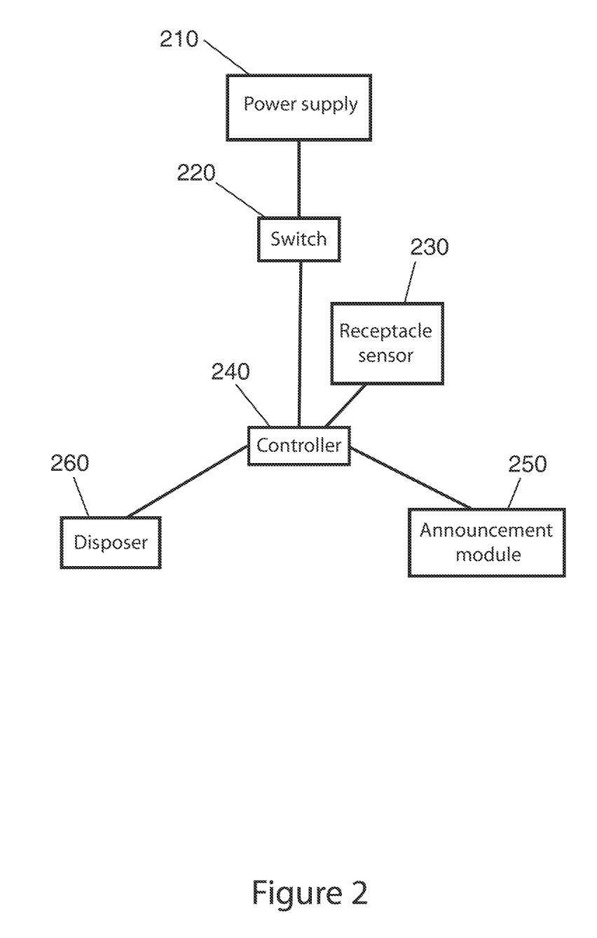

FIG. 2. Illustrates the schematic of the figurine.

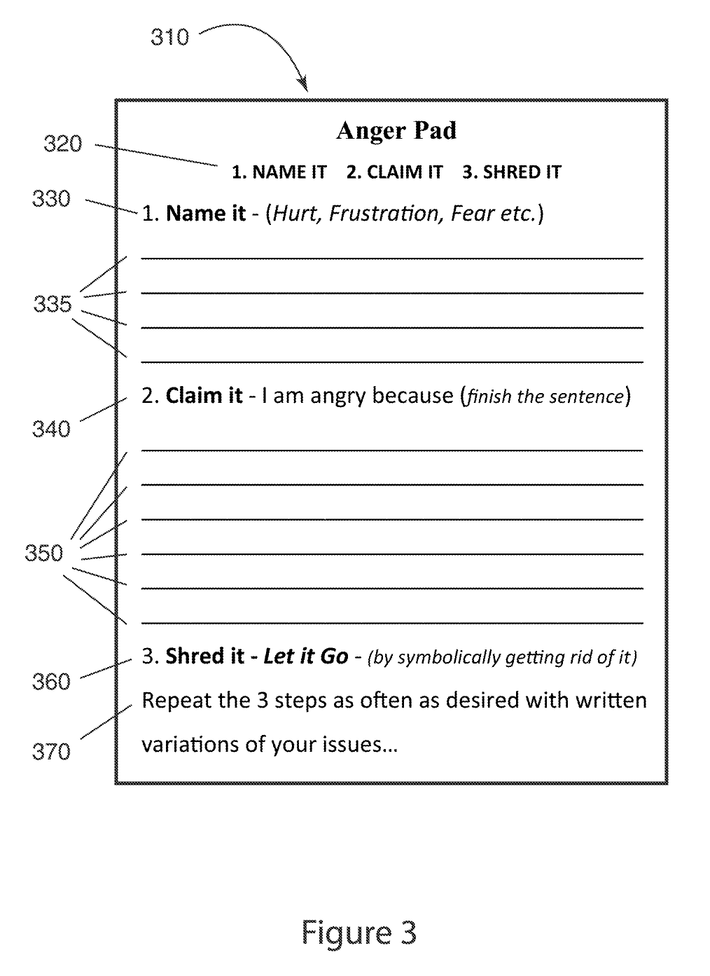

FIG. 3. Illustrates an embodiment of the note.

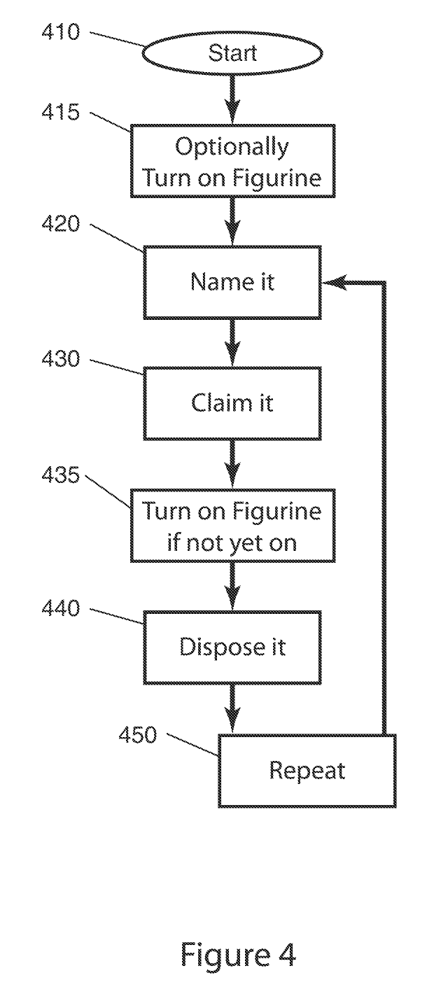

FIG. 4. Illustrates the flow chart of the method.

### BRIEF DESCRIPTION OF DRAWINGS

### Reference Numerals

105 Figurine
110 Note receptacle
120 Switch knob
130 Lid
210 Power supply
220 Switch
230 Receptacle sensor
240 Controller
250 Announcement module
260 Disposer
310 Anger pad
320 User instructions
330 Name it
335 Area to record the name it step.
340 Claim it.
350 Area to record the claim it step.
360 Third step, let it go.
370 User instruction to repeat the three steps.
410 Start.
415 Optionally turn on figurine.
420 Name it.
430 Claim it.
435 Turn on figurine if not yet on.
440 Dispose it.
450 Repeat.

### Nomenclature

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Read this application with the following terms and phrases in their most general form. These definitions are provided to facilitate a clear understanding of the present invention. The general meaning of each of these terms or phrases is illustrative, and not in any way limiting.

The term “disposer” (260) generally refers but is not limited to a device capable of disposing a note. The disposer disposes the note after receiving it by shredding, burning, crushing or otherwise destroying the note. In such case wherein the note is a file stored in a memory device, the disposer would submit the file to the recycle bin. The term “recycle bin” represents a directory on a memory device where deleted files are temporarily stored. The term “icon” generally refers but is not limited to a graphical icon on a memory device.

The term “announcement module” (250) generally refers but is not limited to a device that stores and plays a pre-recorded announcement. The announcement module may be a solid state voice module, a tape recorder, CD player, memory device or other device. The announcement module can make a recording of an audible message or other indicia or receive the message from a CD tape or other storage means. The announcement module can also receive a message through a wired connection such as a USB or wireless such as WiFi. Messages can be stored on tape, CD, a memory device or other storage menas in or associated with the announcement module.

The term “announcement” generally refers to an indicia. This indicia may be an audible message that instructs the user to place notes into the note receptacle (110). The announcement could also be visual, tactile, or other indicia. In an embodiment, the announcement invites the user to symbolically feed their anger or other secondary emotion to the figurine by placing a note into the note receptacle.

The term “controller” (240) generally refers but is not limited to a device that collects and processes input from the switch and receptacle sensor. The controller can be a memory device or an electromechanical device or some combination thereof. The controller, switch and receptacle sensor may be interconnected.

The term “receptacle sensor” (230) generally refers but is not limited to a device that sensors the presence of a note within the note receptacle (110). The receptacle sensor may be a process on a memory device.

The term “switch” (220) generally refers but is not limited to a device that turns the figurine on or off. The switch also may have other states besides on and off, including a setting for automatic operation in which the disposer is turned on when the receptacle sensor detects the presence of a note. The switch may be a process on a memory device.

The term “power supply” (210) generally refers but is not limited to a device that receives power from a power source such as batteries, wiring, a cable such as USB or an AC outlet, and provides this power to the figurine. In an embodiment, the figurine may be an icon, in which case the power supply would be power supply for the memory device.

The term “note receptacle” (110) generally refers but is not limited to a device that accepts notes for entry into the disposer. A receptacle sensor may be associated with the note receptacle. The note receptacle may be the opening to a paper shredder. In another embodiment, the figurine may be an icon having a note receptacle icon that behaves as a note receptacle such that files on a memory device may be dragged and dropped on to the note receptacle icon.

The term “switch knob” (120) generally refers but is not limited to a handle that protrudes from the switch. By moving the switch knob, users can change the state of the switch (220). In another embodiment, the figurine may be an icon having a switch knob icon that behaves as a switch knob such that by interacting with the switch knob icon, users can change the state of the switch.

The term “lid” (130) generally refers but is not limited to an object that covers an opening in the figurine. The lid can be removed to access to the components within the figurine to, for example, discard the disposed notes or change batteries. In another embodiment, the figurine may be an icon having a lid icon that behaves as a lid such that by interacting with the lid icon, users can purge the notes in the recycle bin or trash can if they have not yet been purged wherein purging a file frees up space on a memory device such as a hard disk that had been occupied by the note.

The term “figurine” (105 generally refers but is not limited to an object with a portion containing a note receptacle (110), a switch knob (120), a lid (130), a disposer (260), a announcement module (250), a power supply (210), a switch (220), a receptacle sensor (230) and a controller (240). Another portion of the figurine receives the disposed notes. The figurine (105) shown in FIG. 1 is an example of one embodiment of a figurine. In another embodiment, the figurine may be an icon. In such case where the figurine is an icon on the display of a memory device, the portion that receives the disposed notes is the trash can or recycle bin of a memory device; the note receptacle, switch knob, and lid would be icons associated with the figurine icon; and the disposer, announcement module, switch, receptacle sensor, and controller would be processes run by the memory device.

The term “disposer off signal” generally refers but is not limited to a signal that turns off the disposer. In another embodiment, the figurine may be an icon, the disposer off signal may be generated once the note has been sent to the trash can or recycle bin. The term “disposer on signal” generally refers but is not limited to a signal that turns on the disposer. The term “announcement signal” generally refers but is not limited to a signal that starts the announcement module thereby permitting the announcement module to play the announcement. The term “turn on figurine” generally refers but is not limited a signal to generate announcement signal then either generating a disposer on signal or generating disposer on signal if the receptacle sensor senses a note in the receptacle.

The term “anger pad” (310) generally refers but is not limited to a representation of a note. The term “note” generally refers but is not limited to media on which a user can name it and claim it. The anger pad may be a sheet of paper as shown in FIG. 3. In another embodiment, in which figurine may be an icon associated with a memory device, the note may be a file stored on a memory device.

The term “name it” (420) generally refers but is not limited to the process whereby a user records the primary emotion and other causal factors which are eliciting the secondary emotion. The term “primary emotion” generally refers but is not limited to emotions such as hurt, frustration and fear, that lead to a secondary emotion. The term “secondary emotion” generally refers but is not limited to an emotion such as anger, that is a result of a primary emotion. The term “claim it” (430) generally refers but is not limited to the process whereby a user records the assertion for the events and reasons that have caused the secondary emotion and in doing so claiming that the responsibility for the relationship between the secondary emotion and primary emotion making the user aware of his power to choose his actions and consequently manage his behavior. The term “behavior” generally refers to an action or reaction of the user in response to stimuli such as secondary emotions. The term “dispose it” (440) generally refers but is not limited to the process of disposing the note to symbolically release the secondary emotion such as in releasing the anger felt by the user.

### DESCRIPTION OF INVENTION

Secondary emotions are a response to primary emotions. The acts of name it, claim it and dispose it, remind the user of the user's power to choose a response and thereby to manage their secondary emotion and behavior. When prompted by an announcement from the figurine, the user performs the name it, claim it, and dispose it process. These steps taken together, help the user manage their behavior.

The apparatus of the present invention consists of a figurine (105) as shown in FIG. 1 and a note (310) as shown in FIG. 3. The figurine which may be of any likeness is broadly denoted by numeral (105) includes a note receptacle (110), switch knob (120) and lid (130). The note receptacle receives notes for disposal by a disposer (260) as shown in FIG. 2. The switch knob operates the switch (220) and is used to turn on the system. Disposed notes are collected in a portion of the figurine or, where the figurine is an icon, disposed notes are transferred to. Through interaction with the lid, the disposed notes can be dumped out of the figurine or, where the figurine is an icon, the disposed notes can be emptied from the trash can or recycle bin. In such case that the figurine is a physical object, removal of the lid also provides access to batteries that may be present in the power supply (210). Associated with the note receptacle (110) is a receptacle sensor (230).

The note (310) includes the general instructions (320). The first step (330) of the process is shown wherein the user performs the name it process recording their primary emotion in the area provided (335). The second step (340) of the process is shown wherein the user performs the claim it process recording their secondary emotion in the area provided (350), the secondary emotion, in this example, is anger. The third step (360) of the process is shown wherein the user performs the dispose it process where in the user disposes the note thereby symbolically releasing the secondary emotion, reminding the user of the user's power to choose a response and thereby to manage their secondary emotion and behavior. A final instruction (370) informs the user to repeat the steps as often as desired with written variations of the user's issues.

The method as shown in FIG. 4, for the sake of clarity, progresses from the start block 410. At block 415, the user optionally turns on the Figurine. At block 420, the user performs the name it process. At block 430, the user performs the claim it process. At block 435, the user turns on the figurine if it is not already on. At block 440, the user performs the dispose it process thereby symbolically releasing the associated secondary emotion and reminding the user of the user's power to choose a response and thereby to manage their secondary emotion and behavior. At block 450, the user may decide to repeat steps illustrated by blocks 420, 430, and 440.

In an embodiment, the figurine is an object shaped like a frog (105). The disposer is a paper shredder located in a portion of the figurine. The announcement module is a voice module from AGC Sound. The announcement is the following audible message “Give me your anger, feed me, feed me, feed me”, played at least once. The note is as described in FIG. 3 and is denoted an Anger Pad. The user turns on the figurine with switch knob (120) which causes play back of the announcement. The user performs the name it process (330) recording the primary emotion on the anger pad in the space provided (335). The user performs the claim it process (340) recording the secondary emotion on the anger pad in the space provided (350). The user performs the dispose it process by placing the note into the note receptacle (110) which allows the receptacle sensor to sense the presence of the note and generate disposer on signal. The disposer turns on and shreds the note. In one embodiment, the shredder is left running until the user turns off the figurine with the switch knob. In another embodiment, the disposer turns off when the receptacle sensor detects the absence of a note, and on in the presence of a note. In another embodiment, the announcement is played again after the disposer turns off when the receptacle sensor detects the absence of a note. The user releases their anger by shredding the note and symbolically getting rid of it reminding the user of the user's power to choose a response and thereby to manage their secondary emotion and behavior. The figurine can be emptied of shredded notes by removing the lid (130) and dumping them out. Batteries within the figurine can be accessed via removal of the lid.

In an embodiment, the figurine is an object shaped like a frog (105). The disposer is a paper shredder located in a portion of the figurine. The announcement module is a voice module from AGC Sound. The announcement is the following audible message “Give me your anger, feed me, feed me, feed me”, played at least once. The note is a described in FIG. 3 and is denoted an Anger Pad. The user performs the name it process (330) recording the primary emotion on the anger pad in the space provided (335). The user performs the claim it process (340) recording the secondary emotion on the anger pad in the space provided (335). The user performs the claim it process (340) recording the secondary emotion on the anger pad in the space provided (350). The user turns on the figurine with switch knob (120) which causes play back of the announcement. The user performs the dispose it process by placing the note into the note receptacle (110) which allows the receptacle sensor to sense the presence of the note and generate disposer on signal. The disposer turns on and shreds the note. In one embodiment, the shredder is left running until the user turns off the figurine with the switch knob. In an embodiment, the disposer turns off when the receptacle sensor shredder is left running until the user turns off the figurine with the switch knob. In another embodiment, the disposer turns off when the receptacle sensor detects the absence of a note. The user releases their anger by shredding the note and symbolically getting rid of it. The figurine can be emptied of shredded notes by removing the lid (130) and dumping them out. Batteries within the figurine can be accessed via removal of the lid.

According to another embodiment, the figurine is an icon shaped like a frog (105) on a display screen of a memory device. The disposer is a process on a memory device that sends disposed files to the recycle bin. The announcement module is a process on a memory device that plays audible messages. The announcement is the following audible message “Give me your anger, feed me, feed me, feed me”, played at least once. The note is a file on a memory device as described in FIG. 3 and is denoted an Anger Pad. The user turns on the figurine with switch knob icon (120) which causes play back of the announcement. The user names the primary emotion (330) and records it in the anger pad (335). The user then claims the reason for the behavior, such as anger, by stating and recording (350) that the anger is due to the primary emotion and related causes. The user then places the note into the note receptacle icon (110) by dragging the note and dropping it onto the note receptacle icon which allows the receptacle sensor to sense the presence of the note and generate disposer on signal. The disposer turns on and disposes the note. The user releases their anger by disposing the note and symbolically getting rid of it. The figurine can be emptied of shredded notes by interacting the lid icon (130) to purge the recycle bin or by other means to purge the recycle bin.

According to another embodiment, the figurine is an icon shaped like a frog (105) on a display screen on a memory device. The disposer is a process on a memory device that sends disposed files to the recycle bin. The announcement module is a process on a memory device that plays audible messages. The announcement is the following audible message “Give me your anger, feed me, feed me, feed me”, played at least once. The note is a file on a memory device as described in FIG. 3 and is denoted an Anger Pad. The user turns on the figurine with switch knob icon (120) which causes play back of the announcement. The user performs the name it process (330) recording the primary emotion on the anger pad in the space provided (335). The user performs the claim it process (340) recording the secondary emotion on the anger pad in the space provided (350). The user then places the note into the note receptacle icon (110) by dragging the note and dropping it onto the note receptacle icon which allows the receptacle sensor to sense the presence of the note, generate announcement signal wherein an announcement is played, and generate disposer on signal. The disposer turns on and disposes the note. The user releases their anger by disposing the note and symbolically getting rid of it reminding the user of the user's power to choose a response and thereby to manage their secondary emotion and behavior. The figurine can be emptied of shredded notes by interacting the lid icon (130) to purge the recycle bin or by other means to purge the recycle bin.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

The above illustration provides for many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

All publications and patent applications cited in this specification are herein incorporated by reference as if each individual publication or patent application were specifically and individually indicated to be incorporated by reference.

### APPENDIX A. REFERENCES

Axline, V. M. (1947). Play Therapy. New York: Houghton Miffiin.
Bach, G. and Goldberg, H. (1947). Creative Aggression. New York: Avon Books, pp. 261-283
Berkowitz, L. (1990) On the formation and regulation of anger and aggression: A Cognitive-neoassociationistic analysis. American Psychologist, 45:4, 494-503
Berkowitz, L. (1993). Towards a general theory of anger and emotional aggression: Implications of the cognitive-neoassociationistic perspective for the analysis of anger and other emotions. In R. W. Wyer & T. K. Srull (Eds), perspectives on anger and emotion (Vol. 5, pp. 1-46). Hillsdale, N.J.: Lawrence Erlbaum.
Berne, E. (1964). Games People Play. New York: Grove Press.
Boswell, J. (1982). Helping children with their anger. Elementary School Guidance and Counseling. April 16, pp. 278-287
Briggs, C. D. (1975). Your Child's Self-Esteem. Garden City, N.Y.: Doubleday and Company.
Cahill, A. J. (1981). Aggression revisited: The value of anger in therapy and other Close relationships. Adolescent Psychiatry, 9, pp. 539-549.
Damon, W. (1979). The Social World of the Child. San Francisco: Jossey-Bass.
DiGuiseppe, R. and Tafrate, R. C. (2007) Understanding anger disorders. Oxford University Press, NY.
Dobson, J. (1986). The Strong-Willed Child. Wheaton, 111: Tyndale Press.
Ekman, P., Friesen, W. V., & Ellsworth, P. (1982). What emotion categories or dimensions can observers judge from facial behavior? In P. Ekman (Ed.), Emotion in the human face (pp. 39-55). New York: Cambridge University Press
Forbes, R. (1979). Corporate Stress. Garden City, 65 New York: Doubleday & Company, Inc., pp. 30-35.
Frijda, N. H. (1986). The emotions. New York: Cambridge University Press.
Gray, J. A. (1985). The whole and its parts: Behaviour, the brain, cognition and emotion. Bulletin of the British Psychological Society. 38, 99-112.
Gross, A. M. and Wojnilower, D. A. (1984). Selfdirected behavior change in children: Is it selfdirected? Behavior Therapy, Nov. 15, pp. 501-514.
Hendricks, G. Ph.D. & K. Hendricks Ph.D., Centering And The Art Of Intimacy Handbook, Fireside, N.Y., 1993.
Honig, A. S. (1985). Compliance, Control, and Discipline. Young Children, Mar. 40, pp. 47-52.
Izard, C. E. (1977). Human emotions. New York: Plenum Press
James, W. (1884). What is an emotion? Mind, 9, 188-205.
Jerard, P. The Purpose of Yoga,—Santosha for Your Health, Aura Publications, 2007.
Jones, T. D. (1939). The Development of Certain Motor Skills and Play Activities in Young Children. New York: Teachers College Press.
Kopp, C. B. (1982). Antecedents of self-regulation: A developmental perspective. Child Development, 18, pp. 199-214.
McCandless, B. R. and Trotter, R. J. (1977). Children: Behavior and Development. New York: Holt, Rinehart, and Winston.
McDougall, W. (1926). An introduction to social psychology. Boston: Luce.
Miller, C. S. (1984) Building self-control: Discipline for very young children. Young Children, Nov. 40, pp. 15-19.
Mowrer, O. H. (1960). Learning theory and behavior. New York: Wiley.
Nideffer, R. and Sharpe, R. (1978). How to Put Anxiety Behind You. New York: Stein and Day, pp. 70-74 and pp. 123-127.
Oatley, K., & Johnson-Laird, P. N. (1987). Towards a cognitive theory of emotions. Cognition & Emotion, 1, 29-50.
Oppenheim, J. F. (1984). Kids and Play. New York: Ballantine.
Ortony, A., & Turner, T. J. (1990). What's basic about basic emotions?Psychological Review, 97, 315-331.
Panksepp, J. (1982). Toward a general psychobiological theory of emotions. The Behavioral and Brain Sciences, 5, 407-467.
Parrott, W. (2001), Emotions in Social Psychology, Psychology Press, Philadelphia
Peter, L. and Dana, B. (1982). The Laughter Prescription. New York: Ballantine Books, pp. 22-23.
Piaget, J. (1965). The Moral Judgment of the Child. New York: MacMillan.
Piaget, J. and Inhelder, B. (1969). The Psychology of the Child. New York: Basic Books, Inc.
Plutchik, R. (1980). A general psychoevolutionary theory of emotion. In R. Plutchik & H. Kellerman (Eds), Emotion: Theory, research, and experience: Vol. 1. Theories of emotion (pp. 3-33). New York: Academic.
Rogers, C. (1961). On Becoming A Person. Boston: Houghton Miffiin Company, pp. 314-317. 55
Satir, V. (1972). People Making. Palo Alto, Calif.: Science and Behavior Books, Inc., pp. 20-29.
Schaeffer, C. E. and Millman, H. L. (1981). How to Help Children with Common Problems. New York: Plume.
Skinner, B. F. (1953). Science and Human Behavior. New York: The Free Press, pp. 160-170.
Sound Module product literature, AGC Sound, Division of Apple Corp Technologies, Floral Park, N.Y., 2009.
Tomkins, S. S. (1984). Affect theory. In K. R. Scherer & P. Ekm an (Eds.), Approaches to emotion (pp. 163-195). Hillsdale, N.J.: Erlbaum
Turiel, E. (1986). Potential relations between the development of social reasoning And childhood aggression. Childhood Aggression and Violence: Sources of Influence, prevention, and control. In Press.
Watson, J. B. (1930). Behaviorism. Chicago: University of Chicago Press.
Weiner, B., & Graham, S. (1984). An attributional approach to emotional Development. In C. E. Izard, J. Kagan, & R. B. Zajonc (Eds.), Emotions cognition, and behavior (pp. 167-191). New York: Cambridge University Press

What is claimed is:

1. A method for anger and behavior management comprising:
playing back an announcement,
performing name it;
performing claim it; and
performing dispose it whereby the method reminds that, by taking responsibility for these emotions, a user has the power to choose a response and thereby to manage their secondary emotion and behavior.

2. The method of claim 1, wherein the secondary emotion being claimed is anger.

3. The method of claim 1, wherein the announcement is “Give me your anger, feed me, feed me, feed me”.

4. The method of claim 1, wherein the disposer is a paper shredder.

5. A method for anger and behavior management comprising:
performing name it;
performing claim it;
playing back an announcement; and
performing dispose it whereby the method reminds that, by taking Responsibility for these emotions, the user has the power to choose a response and thereby to manage their secondary emotion and behavior.

6. The method of claim 5, wherein the secondary emotion being claimed is anger.

7. The method of claim 5, wherein the announcement is “Give me your anger, feed me, feed me, feed me”.

8. The method of claim 5, wherein a disposer is a paper shredder.

9. A note wherein a naming is recorded and a claiming is recorded.

10. The note as set forth in claim 9 wherein the note is comprised of paper.

11. The note as set forth in claim 9 wherein the note is comprised of an icon.

12. An apparatus for disposing the note comprising a figurine containing a disposer, a power supply, a switch, a switch knob, a controller, a note receptacle, a lid and an announcement module.

13. An apparatus as set forth in claim 12 wherein said announcement module is a voice module.

14. An apparatus as set forth in claim 12 wherein said disposer is a paper shredder.

15. An apparatus as set forth in claim 12 wherein said apparatus is a memory device.
